(19) United States
(12) Patent Application Publication
(10) Pub. No.: US 2010/0041399 A1
(43) Pub. Date: Feb. 18, 2010

(54) METHOD OF PERFORMING RANGING IN A BROADBAND WIRELESS ACCESS SYSTEM

(76) Inventors: Jeong Ki Kim, Gyeonggi-do (KR); Yong Ho Kim, Gyeonggi-do (KR); Ki Seon Ryu, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/528,981

(22) PCT Filed: Feb. 28, 2008
(86) PCT No.: PCT/KR08/01168

§ 371 Date: Aug. 27, 2009

(30) Foreign Application Priority Data
Feb. 28, 2007 (KR) 10-2007-0020649

(51) Int. Cl. H04W 36/34; H04W 48/20

(52) U.S. Cl. 455/434; 455/436; 375/267; 370/329

(57) ABSTRACT

A method of performing ranging in a broadband wireless access system is disclosed. A method of performing ranging of a mobile station which is in an idle mode in a broadband wireless access system includes requesting ranging by transmitting a third ranging code to a network through a first ranging region allocated by the network to transmit a first ranging code or a second ranging code, and receiving a first ranging response message from the network, the first ranging response message including uplink transmission parameters.

### TECHNICAL FIELD

The present invention relates to a broadband wireless access system, and more particularly, to a method of performing ranging in a broadband wireless access system.

### BACKGROUND ART

FIG. 1 is a flow chart illustrating a network entry procedure when a mobile station is initiated in a broadband wireless access system.

(1) If a mobile station is initially powered on, the mobile station retrieves downlink channels and acquires uplink/downlink synchronization with a base station. At this time, the mobile station receives a downlink-map (DL-MAP) message, an uplink-map (UL-MAP) message, a downlink channel descriptor (DCD) message, and an uplink channel descriptor (UCD) message to acquire uplink and downlink channel parameters.

(2) The mobile station performs ranging with the base station to adjust uplink transmission parameters, and is allocated with basic management connection identifier (CID) and primary management CID from the base station.

(3) The mobile station performs negotiation with the base station regarding basic performance.

(4) The mobile station performs its authentication procedure.

(5) The mobile station is subscribed to the base station, and the mobile station managed by IP is allocated with secondary management CID from the base station.

(6) The mobile station sets IP connection.

(7) The mobile station sets the current date and time.

(8) The mobile station downloads its configuration file from a TFTP server.

(9) The mobile station sets connection of a service which is previously prepared.

A physical layer of a broadband wireless access system is divided into a single carrier scheme and a multiple carrier scheme (OFDM/OFDMA). The multiple carrier scheme uses OFDM, and introduces an OFDMA (Orthogonal Frequency Division Multiple Access) scheme as an access scheme that can allocate resources in a unit of sub-channel by grouping a part of carriers.

A physical layer of the OFDMA scheme divides active carriers into a plurality of groups and transmits the respective groups to different receiving sides. In this way, a group of carriers transmitted to one receiving side are referred to as a sub-channel. Carriers constituting each sub-channel may be located to be adjacent to each other or may be spaced apart from each other at constant intervals. Such multiple access in a unit of sub-channel may increase complexity but is advantageous in that frequency diversity gain and gain according to concentration of power can be obtained, and forward power control can efficiently be performed.

A slot allocated to each user is defined by a data region of a two-dimensional time-frequency sphere, and is a set of continuous sub-channels allocated by burst. One data region in the OFDMA scheme is a rectangular form sectioned by time and sub-channel coordinates. Such a data region can be allocated to an uplink for a specific user, or a base station can transmit the data region to a specific user in a downlink. In order to define such a data region on the two-dimensional sphere, the number of OFDM symbols in the time region and the number of continuous sub-channels starting from a point having an offset from a reference point in the frequency region should be given.

FIG. 2 illustrates a frame structure of a physical layer of an OFDMA scheme in a broadband wireless access system. A downlink sub-frame starts with a preamble used for synchronization and equalization in a physical layer, and a structure of the entire frame is defined through a broadcast type downlink-map (DL-MAP) message and uplink-map (UL-MAP) message which define location and usage of burst allocated to a downlink and an uplink.

The downlink map (DL-MAP) message defines usage allocated per burst for a downlink interval in a burst mode physical layer while the uplink map (UL-MAP) message defines usage of the burst allocated for an uplink interval. An information element constituting the DL-MAP message divides a downlink traffic interval in a user terminal through downlink interval usage code (DIUC), connection ID (CID), and location information of burst (sub-channel offset, symbol offset, the number of sub-channels, and the number of symbols). Meanwhile, usage of an information element constituting the UL-MAP message is defined by uplink interval usage code (UIUC) per CID, and location of a corresponding interval is defined by ‘duration.’ Usage per interval is defined in accordance with UIUC used in the UL-MAP, and each interval starts from a point away from a start point of a previous information element (IE) by ‘duration’ defined in the UL-MAP information element (IE).

The broadband wireless access system supports an idle mode to minimize power consumption of a mobile station (MS). The mobile station does not need to perform a handoff procedure during the idle mode when moving between base stations (BS) included in a single paging zone. Accordingly, the mobile station may not transmit uplink information for the handoff procedure, whereby the power can be saved. The mobile station which is in the idle mode can periodically receive a downlink broadcast message (DL broadcast message) without subscribing to a specific base station when moving among a plurality of base stations.

When the mobile station which is in the idle mode moves among the base stations, the mobile station performs neither handover related procedure nor general action. In the idle mode, the mobile station can save its power by performing scanning during a specific interval (listening interval) only. Also, in the idle mode, if there are pending downlink traffic data to be transmitted from a network to a specific mobile station, the network provides a paging message (MOB_PAG-ADV) to the mobile station and removes air interface and network handover traffic (network HO traffic) from the mobile station which is an inactive state.

For the idle mode, a paging group is defined, wherein the paging group is obtained by grouping a plurality of base stations. In this case, the mobile station does not transmit traffic to the uplink, and is paged through the base station if there is traffic transmitted thereto.

The idle mode starts after de-registration of the mobile station. The mobile station may start the idle mode by transmitting a de-registration request message (DREG-REQ), and the base station may start the idle mode by transmitting an unsolicited de-registration command message (Unsolicited DREG-CMD).

When the mobile station enters the idle mode, a paging controller (e.g., serving BS or network entity) retains information required for the mobile station to perform a network re-entry procedure from the idle mode. The mobile station can request the paging controller to retain information for managing the idle mode by transmitting the de-registration request message (DREG-REQ) which includes idle mode retain information. In response to this de-registration request message, the base station transmits the unsolicited de-registration command message (DREG-CMD) which includes idle mode retain information. An unsolicited method can also include idle mode retain information in the de-registration command message (DREG-CMD).

In a procedure of initiating the idle mode, the mobile station can perform cell selection to select a new preference base station. The preference base station is a base station evaluated by the mobile station, and the mobile station selects a base station having the best air interface DL properties as the preference base station. In the procedure of evaluating and selecting the preference base station, the mobile station synchronizes with the preference base station and acquires a frame size and a frame number by decoding DCD and DL-MAP transmitted from the preference base station. The mobile station uses the frame size and the frame number to determine the time from the preference base station to next base station paging interval (BS paging interval).

During a paging unavailable interval (MS Paging Unavailable Interval), the mobile station performs actions such as power down, neighboring base station scanning, preference base station re-selection, and ranging. The mobile station receives and decodes a base station broadcast paging message (BS broadcast paging message) during a paging listening interval (MS Paging Listening Interval). The mobile station performs scanning and decoding of a downlink channel descriptor (DCD) and a downlink-map (DL-MAP) during MS paging unavailable interval before receiving the paging message, and downlink-synchronizes with the base station.

The base station broadcast paging message is a mobile station notification message (MS notification message) for indicating the presence of downlink traffic of a specific mobile station through the base station or other network entity or polling the mobile station, and for requesting location update in a state that the mobile station does not completely enter the network.

The mobile station can terminate the idle mode at any time. If the mobile station receives the base station broadcast paging message which includes action code ‘0b10’ representing ‘MS MAC Address Hash’ and ‘Enter Network,’ the mobile station terminates the idle mode and performs a network re-entry procedure. If the mobile station receives the base station broadcast paging message which includes action code ‘0b01’ representing ‘MS MAC Address Hash’ and ‘Perform Ranging,’ the mobile station performs idle mode location update to notify the network of its location.

As shown in FIG. 1, in a procedure of performing an initial network registration, a procedure of allowing the mobile station to adjust transmission parameters (frequency offset, time offset, and transmission power) for uplink communication with the base station is referred to as initial ranging. After performing the network registration procedure, the mobile station performs periodic ranging to continue to retain uplink communication with the base station. In addition, examples of ranging types include handover ranging for simplifying a handover procedure when the mobile station performs the handover procedure, and a bandwidth-request ranging performed when the mobile station requests uplink bandwidth due to the occurrence of data to be transmitted.

In the broadband wireless access system, CDMA code sets and a region to which CDMA code will be transmitted are allocated through UL-MAP by the network, wherein the CDMA code sets and the region are used when ranging is performed depending on the ranging types. Accordingly, in order that a specific mobile station performs handover ranging, the mobile station selects a specific code among the CDMA codes for handover ranging and transmits the selected code to the network through a region for initial ranging and handover ranging. In this way, the network can identify a type of ranging through the received CDMA code and the region to which the CDMA code has been transmitted.

As described above, even in case that the mobile station which is in the idle mode terminates the idle mode and performs network re-entry and idle mode location update, ranging should be performed. Also, in case that the network receives ranging request from the mobile station which intends to terminate the idle mode, the network needs to identify that the ranging request is received from the mobile station which intends to terminate the idle mode and perform network re-entry, whereby network re-entry can desirably be performed.

However, in a ranging method according to the related art, since a CDMA code or a ranging region for the mobile station which intends to terminate the idle mode and try network re-entry is not separately allocated, a problem occurs in that the network cannot identify that ranging requested from the mobile station is to terminate the idle mode and try network re-entry. If the mobile station which terminates the idle mode and tries network re-entry performs ranging by selecting a CDMA code for one of the four ranging types, for example, handover ranging, and transmitting the selected CDMA code through a region for initial ranging and handover ranging, collision may occur between this mobile station and another mobile station which performs handover.

As another method, a separate CDMA code and a dedicated ranging region for the mobile station which terminates the idle mode and tries network re-entry may be allocated. However, this method could lead to a problem that uplink resources may be wasted.

### DISCLOSURE OF THE INVENTION

Accordingly, the present invention is directed to a method of performing ranging in a broadband wireless access system, which substantially obviates one or more problems due to limitations and disadvantages of the related art.

An object of the present invention is to provide a method of performing ranging in a broadband wireless access system, in which a mobile station which terminates an idle mode and tries network re-entry performs ranging.

Another object of the present invention is to provide a method of performing ranging in a broadband wireless access system, in which if a mobile station which terminates an idle mode and tries network re-entry performs ranging, collision can be avoided between this mobile station and another mobile station which performs another type of ranging.

Other object of the present invention is to provide a method of performing ranging in a broadband wireless access system, in which uplink resources can be prevented from being wasted.

To achieve these objects and other advantages and in accordance with the purpose of the invention, as embodied and broadly described herein, a method of performing ranging of a mobile station which is in an idle mode in a broadband wireless access system includes requesting ranging by transmitting a third ranging code to a network through a first ranging region allocated by the network to transmit a first ranging code or a second ranging code, and receiving a first ranging response message from the network, the first ranging response message including uplink transmission parameters.

In another aspect of the present invention, a method of performing ranging for a mobile station which is in an idle mode in a broadband wireless access system includes receiving a third ranging code from the mobile station through a first ranging region allocated to transmit a first ranging code or a second ranging code, and transmitting a ranging response message to the mobile station, the ranging response message including uplink transmission parameters.

In still another aspect of the present invention, a method of performing ranging of a mobile station which is in an idle mode in a broadband wireless access system which uses multiple carriers includes requesting ranging by repeatedly transmitting a specific code selected from code sets for periodic ranging to a network during two OFDM symbols, and receiving a ranging response message from the network, the ranging response message including uplink transmission parameters.

In further still another aspect of the present invention, a method of performing ranging of a mobile station which is in an idle mode in a broadband wireless access system which uses multiple carriers includes requesting ranging by repeatedly transmitting two continuous codes selected from code sets for periodic ranging to a network during two OFDM symbols, and receiving a ranging response message from the network, the ranging response message including uplink transmission parameters.

In further still another aspect of the present invention, a method of performing ranging for a mobile station which is in an idle mode in a broadband wireless access system which uses multiple carriers includes repeatedly receiving a code selected from code sets allocated for periodic ranging, from the mobile station during two OFDM symbols, and transmitting a ranging response message to the mobile station, the ranging response message including uplink transmission parameters.

In further still another aspect of the present invention, a method of performing ranging for a mobile station which is in an idle mode in a broadband wireless access system which uses multiple carriers includes repeatedly receiving two continuous codes selected from code sets allocated for periodic ranging, from the mobile station during two OFDM symbols, and transmitting a ranging response message to the mobile station, the ranging response message including uplink transmission parameters.

In further still another aspect of the present invention, a method of performing ranging in a mobile station which is in an idle mode in a broadband wireless access system includes receiving a message from a network, the message allocating a first ranging region for transmission of a first ranging code or a second ranging code and a second ranging region for transmission of a third ranging code or a fourth ranging code, transmitting a third ranging code to the network through the first ranging region, and receiving a ranging response message from the network, the ranging response message including uplink transmission parameters.

In further still another aspect of the present invention, a method of performing ranging for a mobile station which is in an idle mode in a broadband wireless access system includes allocating a first ranging region for transmission of a first ranging code or a second ranging code and a second ranging region for transmission of a third ranging code or a fourth ranging code, receiving a third ranging code from the mobile station through the first ranging region, and transmitting a ranging response message to the mobile station, the ranging response message including uplink transmission parameters.

In further still another aspect of the present invention, a mobile station which tries network re-entry in an idle mode of a broadband wireless access system is set to perform the steps of receiving a message from a network, the message allocating a first ranging region for transmission of a first ranging code or a second ranging code and a second ranging region for transmission of a third ranging code or a fourth ranging code, transmitting a third ranging code from the mobile station through the first ranging region, and receiving a ranging response message from the network, the ranging response message including uplink transmission parameters.

### BRIEF DESCRIPTION OF THE DRAWINGS

FIG. 1 is a flow chart illustrating a network entry procedure when a mobile station is initiated in a broadband wireless access system;

FIG. 2 illustrates a frame structure of a physical layer of an OFDMA scheme in a broadband wireless access system;

FIG. 3 is a flow chart illustrating a procedure according to the preferred embodiment of the present invention;

FIG. 4A and FIG. 4B illustrate detailed embodiments that a mobile station transmits CDMA code for periodic ranging to a base station through an initial/handover ranging region in the embodiment of FIG. 3; and

FIG. 5 is a flow chart illustrating another procedure according to the preferred embodiment of the present invention.

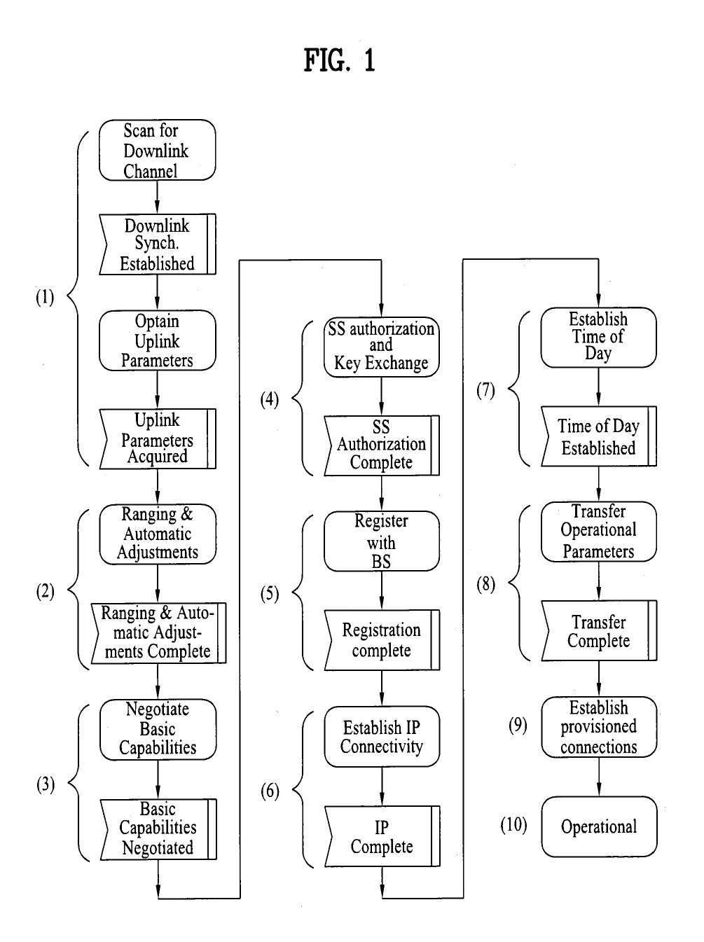

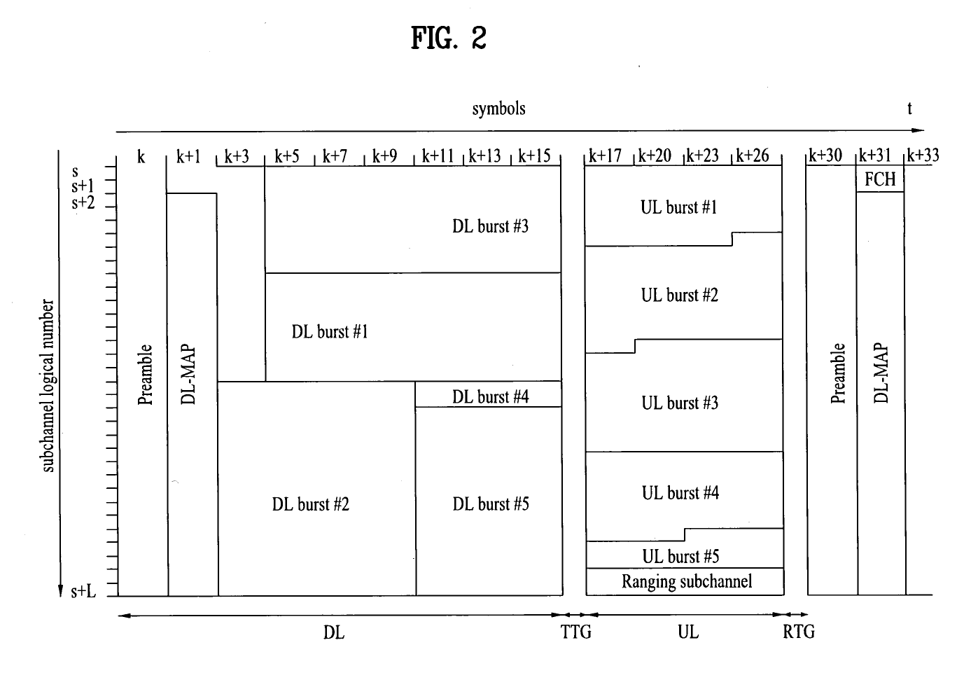

### BEST MODE FOR CARRYING OUT THE INVENTION

Hereinafter, structures, operations, and other features of the present invention will be understood readily by the preferred embodiments of the present invention, examples of which are illustrated in the accompanying drawings. Embodiments described later are examples in which technical features of the present invention are applied to a broadband wireless access system. IEEE Std 802.16e™, “IEEE Standard for Local and metropolitan area networks, Part 16: Air Interface for Fixed and Mobile Broadband Wireless Access Systems,” which is the standard of the broadband wireless access system, can be referred to, so as to obtain detailed information related to a method of performing ranging in a broadband wireless access system and an idle mode.

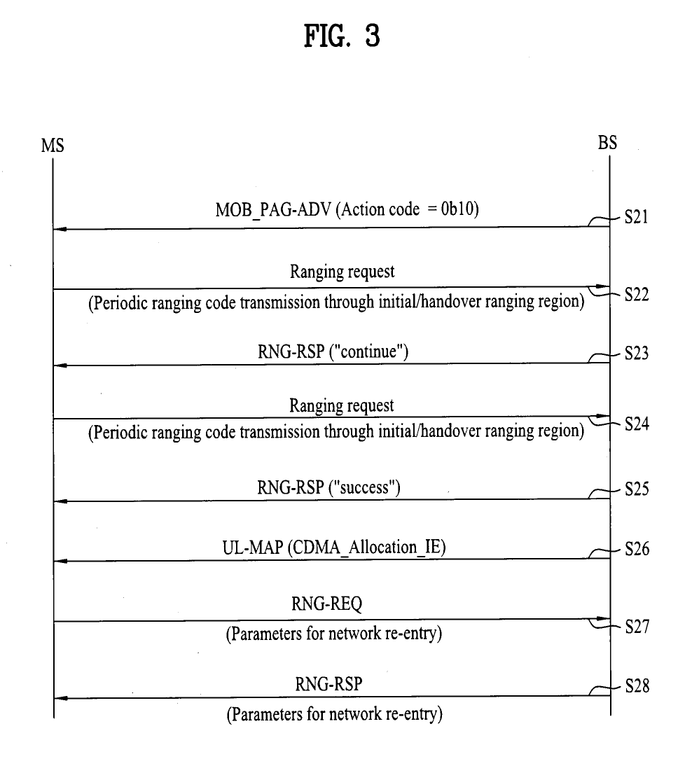

FIG. 3 is a flow chart illustrating a procedure according the embodiment of the present invention. The embodiment of FIG. 3 relates to a method of performing ranging to terminate an idle mode and re-enter a network after a mobile station which is in an idle mode receives a paging message from the network. Hereinafter, procedures of transmitting and receiving messages for performing ranging between a mobile station (MS) and a base station (BS) which is a terminal node of the network will be described.

Referring to FIG. 3, if there are downlink data to be transmitted to the mobile station which is in the idle mode during a paging listening interval (MS Paging Listening Interval), the base station transmits a paging message (MOB_PAG-ADV), of which an action code is set to ‘0b10’ (Enter Network), to the mobile station to indicate the presence of the downlink data [S21]. The mobile station performs a network re-entry procedure after receiving the paging message from the base station.

The mobile station selects one or two codes from CDMA code sets for periodic ranging and transmits the selected code(s) to the base station through an initial/handover ranging region so as to request ranging [S22].

In a broadband wireless access system of an OFDMA scheme, the mobile station performs uplink bandwidth request and ranging request for adjusting uplink transmission parameters by using CDMA codes. The base station forwards a CDMA code set for ranging to mobile stations in a broadcast type through an uplink channel descriptor (UCD) message. Table 1 and Table 2 illustrate examples of UCD message and type length value (TLV) parameters related to ranging and bandwidth request included in the UCD message, respectively.

TABLE 1

| Syntax | Size | Notes |
|---|---|---|
| UCD_Message_Format( ) { | | |
| Management Message Type = 0 | 8 bits | |
| Configuration Change Count | 8 bits | |
| Ranging Backoff Start | 8 bits | |
| Ranging Backoff End | 8 bits | |
| Request Backoff Start | 8 bits | |
| Request Backoff End | 8 bits | |
| TLV Encoded information for | variable | TLV specific |
| the overall channel | | |
| Begin PHY Specific Section { | | See applicable PHY section. |
| for(i= 1; i <= n; i++) { | | For each uplink burst profile |
| | | 1 to n. |
| Uplink_Burst_Profile | variable | PHY specific |
| } | | |
| } | | |
| } | | |

TABLE 2

| | Type | | |
|---|---|---|---|
| Name | (1 byte) | Length | Value |
| Initial ranging | 150 | 1 | Number of initial ranging CDMA codes. Possible |
| codes | | | values are 0-255.a |
| Periodic | 151 | 1 | Number of periodic ranging CDMA codes. Possible |
| ranging codes | | | values are 0-255.a |
| Handover | 194 | 1 | Number of handover ranging CDMA codes. Possible |
| ranging codes | | | values are 0-255.a |
| Bandwidth | 152 | 1 | Number of bandwidth request codes. Possible values |
| request codes | | | are 0-255.a |
| Periodic | 153 | 1 | Initial backoff window size for periodic ranging |
| ranging backoff | | | contention, expressed as a power of 2. Range: 0-15 |
| start | | | (the highest order bits shall be unused and set to 0). |
| Periodic | 154 | 1 | Final backoff window size for periodic ranging |
| ranging backoff | | | contention, expressed as a power of 2. Range: 0-15 |
| end | | | (the highest order bits shall be unused and set to 0). |
| Start of ranging | 155 | 1 | Indicates the starting number, S, of the group of |
| codes group | | | codes used for this uplink. All the ranging codes |
| | | | used on this uplink will be between S and |
| | | | ((S + N + M + L + O) mod 256). Where, N is the number |
| | | | of initial-ranging codes. M is the number of |
| | | | periodic-ranging codes. L is the number of |
| | | | bandwidth-request codes. O is the number of |
| | | | handover-ranging codes. The range of values is 0 S |
| | | | ≦≦255 |

The downlink channel descriptor (DCD) message and the uplink channel descriptor (UCD) message are MAC management messages which include uplink and downlink channel parameters of the base station, and are transmitted to the mobile stations from the base station in a broadcast type at a constant period. The mobile stations acquire information of a coding and modulation scheme of each burst from the DCD/UCD messages, and perform coding/decoding of data through the acquired information. A mobile station determines that channel parameters of the base station have been changed by receiving the DCD/UCD messages, which are transmitted periodically, and updates the changed channel parameters through the DCD/UCD messages. Profile information related to a coding and modulation scheme of an uplink burst, a CDMA code set according to each ranging type, and backoff time applied during collision after code transmission of the mobile station are defined in the UCD message.

The base station allocates a ranging region to the mobile stations based on contention through an uplink map information element included in UL-MAP. At this time, the base station divides the ranging region into an initial/handover ranging region and a periodic/bandwidth-request ranging region.

The mobile station randomly selects a suitable ranging code from CDMA code sets for each ranging type, which are acquired from the UCD message, and transmits the selected ranging code to each uplink interval. For example, the mobile station which performs initial ranging selects a specific code from the CDMA code sets for initial ranging, which are acquired from the UCD message, and transmits the selected specific code to the base station through the initial/handover ranging region, thereby requesting initial ranging. Also, in case of periodic ranging, the mobile station selects a specific code from the CDMA code sets for periodic ranging, and transmits the selected specific code to the base station through the periodic/bandwidth request ranging region, thereby requesting periodic ranging.

The embodiment according to the present invention is characterized in that the mobile station which is in the idle mode selects one or two codes from the CDMA code sets for periodic ranging to request ranging for network re-entry and transmits the selected code(s) to the base station through the initial/handover ranging region. In this way, the mobile station which is in the idle mode can identify one type of ranging from another type of ranging. If the base station receives the CDMA code for periodic ranging through the initial/handover ranging region, the base station can identify that the mobile station which is in the idle mode requests ranging for network re-entry.

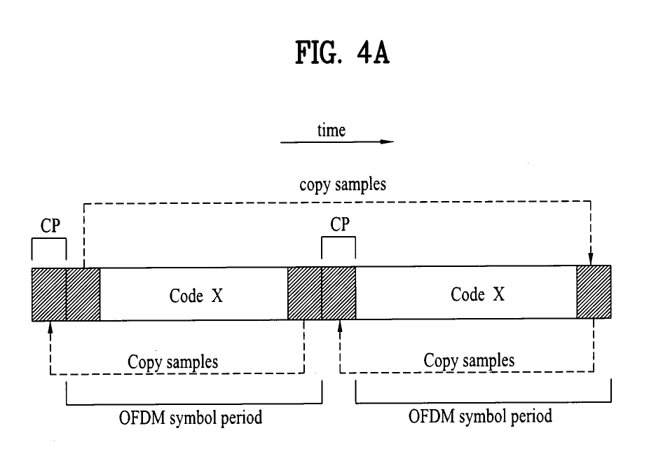

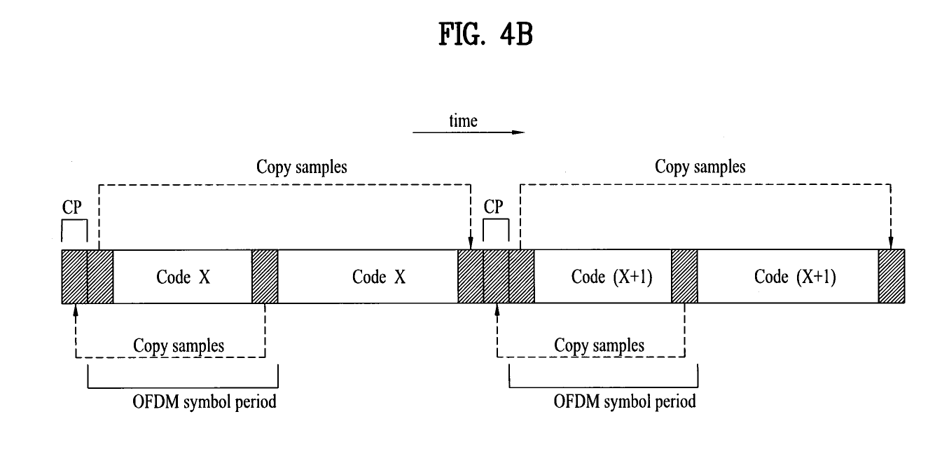

FIG. 4A and FIG. 4B illustrate detailed embodiments that the mobile station transmits the CDMA code for periodic ranging to the base station through the initial/handover ranging region in accordance with the embodiment of FIG. 3.

FIG. 4A illustrates that two OFDM symbols are allocated to the initial/handover ranging region. In FIG. 4A, the mobile station selects a specific code (code X) from the CDMA code sets for periodic ranging, which are allocated from the base station through the UCD message, and repeatedly transmits the selected specific code during two OFDM symbols, thereby requesting the base station of ranging.

FIG. 4B illustrates that four OFDM symbols are allocated to the initial/handover ranging region. In FIG. 4B, the mobile station selects two continuous codes (code X and code (X+1)) from the CDMA code sets for periodic ranging, which are allocated from the base station through the UCD message, and repeatedly transmits the selected codes during the two OFDM symbols, thereby requesting the base station of ranging.

In the broadband wireless access system according to IEEE 802.16e, one ranging channel is comprised of a group of six (PUSC) or eight (O-PUSC/AMC) adjacent channels. Indexes of subchannels constituting one ranging channel is designated through UL-MAP. The mobile station transmits a specific CDMA code selected for ranging to the base station by coding the specific CDMA code to sub-carriers of the ranging channel by one bit per sub-carrier in a BPSK mode. Namely, each bit of the CDMA code having a length of 144 bits is coded by a group of six or eight adjacent subchannels.

If it is determined that the mobile station should still adjust uplink synchronization, the base station which has received the periodic ranging code from the mobile station through the initial/handover ranging region transmits a ranging response message (RNG-RSP), of which ranging status is set to ‘continue,’ to the mobile station [S23]. A transmission power adjustment value for uplink synchronization, a time and frequency adjustment value, and a ranging status (success, fail) are set in the ranging response message. Table 3 illustrates an example of a data format of the ranging response message, and Table 4 illustrates a data format of a type length value (TLV) included in the ranging response message of Table 3.

TABLE 3

| Syntax | Size | Notes |
|---|---|---|
| RNG-RSP_Message_Format( ) { | | |
| Management Message Type = 5 | 8 bits | |
| Uplink Channel ID | 8 bits | |
| TLV Encoded Information | variable | TLV specific |
| } | | |

TABLE 4

| | Type | | |
|---|---|---|---|
| Name | (1 byte) | Length | Value (variable-length) |
| Timing Adjust | 1 | 4 | Tx timing offset adjustment (signed 32-bit). The time |
| | | | required to advance SS transmission so frames arrive |
| | | | at the expected time instance at the BS. Units are |
| | | | PHY specific (see 10.3). |
| Power Level | 2 | 1 | Tx Power offset adjustment (signed 8-bit, 0.25 dB |
| Adjust | | | units) Specifies the relative change in transmission |
| | | | power level that the SS is to make in order that |
| | | | transmissions arrive at the BS at the desired power. |
| | | | When subchannelization is employed, The subscriber |
| | | | shall interpret the power offset adjustment as a |
| | | | required change to the transmit-ted power density. |
| Offset Frequency | 3 | 4 | Tx frequency offset adjustment (signed 32-bit, Hz |
| Adjust | | | units) Specifies the relative change in transmission |
| | | | frequency that the SS is to make in order to better |
| | | | match the BS. (This is fine-frequency adjustment |
| | | | within a channel, not reassignment to a different |
| | | | channel.) |
| Ranging Status | 4 | 1 | Used to indicate whether uplink messages are |
| | | | received |
| | | | within acceptable limits by BS. |
| | | | 1 = continue, 2 = abort, 3 = success, 4 = rerange |
| Ranging code | 150 | 4 | Bits 31:22 - Used to indicate the OFDM time symbol |
| attributes | | | reference that was used to transmit the ranging code. |
| | | | Bits 21:16 - Used to indicate the OFDMA |
| | | | subchannel |
| | | | reference that was used to transmit the ranging code. |
| | | | Bits 15:8 - Used to indicate the ranging code index |
| | | | that was sent by the SS. |
| | | | Bits 7:0 - The 8 least significant bits of the frame |
| | | | number of the OFDMA frame where the SS sent the |
| | | | ranging code. |

The mobile station which has received the ranging response message (RNG-RSP) of which ranging status is set to ‘continue’ selects one or two codes from the CDMA code sets for periodic ranging and transmits the selected code(s) to the base station through the initial/handover ranging region by means of the method of FIG. 4A or FIG. 4B, thereby requesting ranging once more [S24].

If it is determined that the mobile station does not need to adjust uplink synchronization any more, the base station which has received the periodic ranging code from the mobile station through the initial/handover ranging region transmits a ranging response message (RNG-RSP), of which ranging status is set to ‘success,’ to the mobile station [S25]. A data format of the ranging response message can be referred to Table 3 and Table 4. At this time, the ranging status in Table 4 is set to ‘success.’

After transmitting the ranging response message (RNG-RSP), of which ranging status is set to ‘success,’ to the mobile station, the base station allocates an uplink resource, i.e., a time-frequency region to the mobile station through CDMA_Allocation_IE included in the uplink-map (UL-MAP) in order that the mobile station transmits a ranging request message (RNG-REQ) [S26]. At this time, the base station allocates a sufficient region so that the mobile station which is in the idle mode can include TLVs related to network re-entry in the ranging request message (RNG-REQ).

The mobile station transmits the ranging request message (RNG-REQ) through the region allocated from the base station, wherein the ranging request message includes TLVs related to network re-entry, such as MAC address of the mobile station, paging controller ID TLV, ranging purpose indication TLV, and HMAC/CMAC Tuple TLV [S27].

After receiving the ranging request message (RNG-REQ) from the mobile station, the base station transmits the ranging response message (RNG-RSP) to the mobile station, wherein the ranging response message includes various TLVs related to network re-entry, such as management CIDs, paging controller ID TLV, and HMAC/CMAC Tuple TLV [S28].

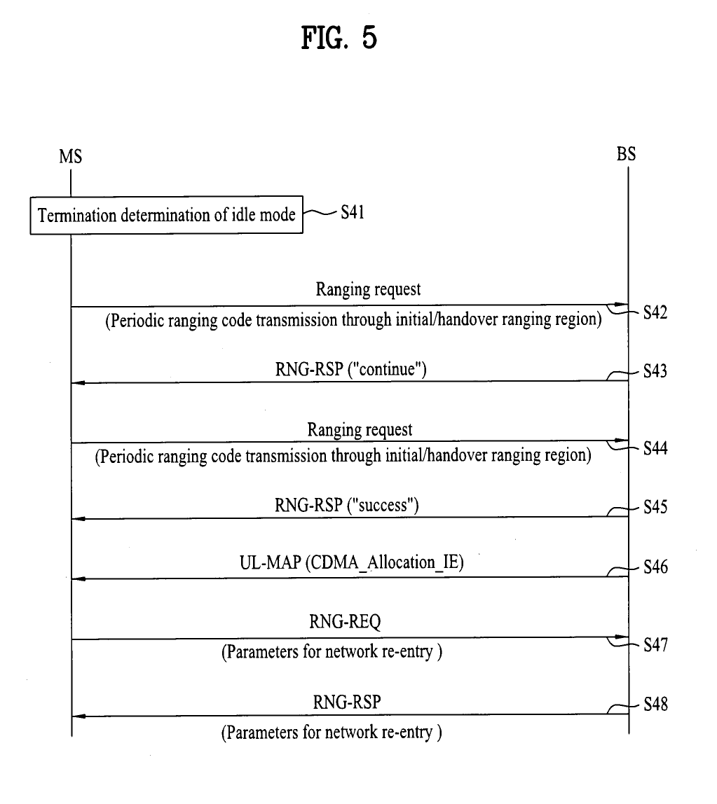

FIG. 5 is a flow chart illustrating another procedure according to an embodiment of the present invention. The embodiment of FIG. 5 relates to a method of performing ranging in order that the mobile station which is in the idle mode spontaneously terminates the idle mode and re-enters the network.

In FIG. 5, if there are messages to be transmitted, or if it is necessary to terminate the idle mode due to other circumstances, the mobile station which is in the idle mode determines termination of the idle mode [S41]. Later steps [S42 to S48] for ranging are performed in the same manner as steps S22 to S28 performed after the mobile station receives the paging message (MOB_PAG-ADV) from the base station in FIG. 3. Accordingly, detailed description of the steps S42 to S48 can be referred to the description of the embodiment illustrated in FIG. 3.

The embodiments of FIG. 4 and FIG. 5 relate to an example that the mobile station which is in the idle mode selects one or two codes from CDMA code sets for periodic ranging and transmits the selected code(s) to the base station through the initial/handover ranging region, thereby requesting ranging for network re-entry. As another embodiment, there may be considered a method of selecting one or two codes from CDMA code sets for bandwidth request ranging and transmitting the selected code(s) to the base station through the initial/handover ranging region, thereby requesting ranging for network re-entry. Moreover, there may be considered a method of transmitting at least one code included in CDMA code sets for initial ranging or handover ranging through the periodic/bandwidth ranging region.

According to embodiments of the present invention, if the mobile station which terminates the idle mode and tries network re-entry performs ranging, it is possible to avoid collision with the mobile stations which perform another types or ranging, and to prevent uplink resources from being wasted.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention have been described based on data transmission and reception between the base station and the mobile station. A specific operation which has been described as being performed by the base station may be performed by an upper node of the base station as the case may be. In other words, it will be apparent that various operations performed for communication with the mobile station in the network which includes a plurality of network nodes along with the base station may be performed by the base station or network nodes other than the base station. The base station may be replaced with terms such as a fixed station, Node B, eNode B (eNB), and access point. Also, the mobile station may be replaced with terms such as user equipment (UE) and mobile subscriber station (MSS).

The embodiments according to the present invention may be implemented by various means, for example, hardware, firmware, software, or their combination. If the embodiment according to the present invention is implemented by hardware, the embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the method of transmitting and receiving data in the wireless communication system according to the embodiment of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The present invention can be applied to a wireless communication system such as a mobile communication system or a wireless Internet system.

1. A method of performing ranging of a mobile station which is in an idle mode in a broadband wireless access system, the method comprising:
requesting ranging by transmitting a third ranging code to a network through a first ranging region allocated by the network to transmit a first ranging code or a second ranging code; and
receiving a first ranging response message from the network, the first ranging response message including uplink transmission parameters.

2. The method of claim 1, further comprising receiving a paging message from the network before requesting ranging.

3. The method of claim 1, further comprising:
receiving an information element (IE) from the network, the information element allocating channel resources for transmission of a ranging request message; and
transmitting the ranging request message by using the allocated channel resources, the ranging request message including parameters related to network re-entry.

4. The method of claim 3, further comprising receiving a second ranging response message from the network, the second ranging response message including parameters related to network re-entry.

5. The method of claim 1, wherein the first ranging code is a code selected from code sets for initial ranging, the second ranging code is a code selected from code sets for handover ranging, and the third ranging code is a code selected from code sets for periodic ranging.

6. A method of performing ranging for a mobile station which is in an idle mode in a broadband wireless access system, the method comprising:
receiving a third ranging code from the mobile station through a first ranging region allocated to transmit a first ranging code or a second ranging code; and
transmitting a ranging response message to the mobile station, the ranging response message including uplink transmission parameters.

7. The method of claim 6, wherein the first ranging code is a code selected from code sets for initial ranging, the second ranging code is a code selected from code sets for handover ranging, and the third ranging code is a code selected from code sets for periodic ranging.

8. A method of performing ranging of a mobile station which is in an idle mode in a broadband wireless access system which uses multiple carriers, the method comprising:
requesting ranging by repeatedly transmitting a specific code selected from code sets for periodic ranging to a network during two OFDM symbols; and
receiving a ranging response message from the network, the ranging response message including uplink transmission parameters.

9. A method of performing ranging of a mobile station which is in an idle mode in a broadband wireless access system which uses multiple carriers, the method comprising:
requesting ranging by repeatedly transmitting each of two continuous codes selected from code sets for periodic ranging to a network during two OFDM symbols, respectively; and
receiving a ranging response message from the network, the ranging response message including uplink transmission parameters.

10. A method of performing ranging for a mobile station which is in an idle mode in a broadband wireless access system which uses multiple carriers, the method comprising:
repeatedly receiving a code selected from code sets allocated for periodic ranging, from the mobile station during two OFDM symbols; and
transmitting a ranging response message to the mobile station, the ranging response message including uplink transmission parameters.

11. A method of performing ranging for a mobile station which is in an idle mode in a broadband wireless access system which uses multiple carriers, the method comprising:
repeatedly receiving each of two continuous codes selected from code sets allocated for periodic ranging, from the mobile station during two OFDM symbols, respectively; and
transmitting a ranging response message to the mobile station, the ranging response message including uplink transmission parameters.

12. A method of performing ranging in a mobile station which is in an idle mode in a broadband wireless access system, the method comprising:
receiving a message from a network, the message allocating a first ranging region for transmission of a first ranging code or a second ranging code and a second ranging region for transmission of a third ranging code or a fourth ranging code;
transmitting a third ranging code to the network through the first ranging region; and
receiving a ranging response message from the network, the ranging response message including uplink transmission parameters.

13. A method of performing ranging for a mobile station which is in an idle mode in a broadband wireless access system, the method comprising:
allocating a first ranging region for transmission of a first ranging code or a second ranging code and a second ranging region for transmission of a third ranging code or a fourth ranging code;
receiving a third ranging code from the mobile station through the first ranging region; and
transmitting a ranging response message to the mobile station, the ranging response message including uplink transmission parameters.

14. The method of claim 12, wherein the first ranging code is a code selected from code sets for initial ranging, the second ranging code is a code selected from code sets for handover ranging, and the third ranging code is a code selected from code sets for periodic ranging.

15. A mobile station which tries network re-entry in an idle mode of a broadband wireless access system, the mobile station being configured to perform the steps of:
receiving a message from a network, the message allocating a first ranging region for transmission of a first ranging code or a second ranging code and a second ranging region for transmission of a third ranging code or a fourth ranging code;
transmitting a third ranging code from the mobile station through the first ranging region; and
receiving a ranging response message from the network, the ranging response message including uplink transmission parameters.

16. The mobile station of claim 15, wherein the first ranging code is a code selected from code sets for initial ranging, the second ranging code is a code selected from code sets for handover ranging, and the third ranging code is a code selected from code sets for periodic ranging.
